(19) United States
(12) Patent Application Publication
(10) Pub. No.: US 2013/0153510 A1
(43) Pub. Date: Jun. 20, 2013

(54) METHOD AND SYSTEM FOR TREATING AQUEOUS STREAMS

(71) Applicants: Kaj Jansson, Tampere (FI); Iiris Joensuu, Espoo (FI); Marjatta Piironen, Oulu (FI); Jukka-Pekka Sirviö, Espoo (FI); Tapio Yrjänäinen, Petsmo (FI)

(72) Inventors: Kaj Jansson, Tampere (FI); Iiris Joensuu, Espoo (FI); Marjatta Piironen, Oulu (FI); Jukka-Pekka Sirviö, Espoo (FI); Tapio Yrjänäinen, Petsmo (FI)

(73) Assignee: KEMIRA OYJ, Helsinki (FI)

(21) Appl. No.: 13/810,839

(22) PCT Filed: Jul. 19, 2011
(86) PCT No.: PCT/FI2011/050666

§ 371 Date: Mar. 4, 2013

(30) Foreign Application Priority Data
Jul. 20, 2010 (FI) 2010 5814

(51) Int. Cl. C02F 1/52

(52) U.S. Cl. CPC C02F 1/5209
USPC 210/727; 210/702; 210/731; 210/735; 210/732; 210/733; 210/723; 210/728; 210/726; 210/85

(57) ABSTRACT

The invention relates to a method and system for treating an aqueous stream having a first flow rate and containing solid matter exhibiting first settling properties, the method comprising adding a modifying agent to the aqueous stream at an addition rate sufficient to change the first settling properties of the aqueous stream to obtain a modified aqueous stream having solid matter exhibiting second settling properties different from the first settling properties; taking batchwise samples of the modified aqueous stream to a settling vessel having a volume; determining a settling property of the solid matter of the samples in the settling vessel; and conducting the modified aqueous stream to a separation unit in which solid matter is separated from the modified aqueous stream. The invention provides a convenient way of monitoring and/or controlling aqueous streams conducted for example to purification processes.

### BACKGROUND OF THE INVENTION

1. Field of the Invention

The present invention relates to treatment of aqueous streams. In particular, the present invention concerns a method wherein an aqueous stream which contains solid matter in suspended and/or colloidal form or dissolved matter which may be precipitated, is treated with a modification chemical in a sufficient amount to affect the settling properties, in particular the settling time, of the solid or dissolved matter. In addition, the invention relates to a water treatment system.

2. Description of Related Art

Examples of aqueous streams containing significant amounts of solid matter and/or dissolved matter which may be precipitated, include wastewater effluents, such as sewage and other waste waters of industrial and municipal origin as well as industrial circulations flows, such as circulation flows in the paper and pulp industry. Depending on the origin of the aqueous stream, the solid matter can be organic or inorganic or a combination thereof. There may also be included some biological matter. The solid matter concentration, including precipitable dissolved matter, can vary broadly. Typically, it ranges from about 0.1 to 50% by weight of the aqueous flow.

Common for many streams of the above kind is that there is a need to regulate the settling properties of solid matter which is present in suspended, colloidal or precipitable form in the water. In the following all of these phenomena will be referred to as “solid matter”.

Treatment of the waste water generally requires that the solid matter contained in it is separated within a reasonably short period of time. Separation is typically carried out by settling or flotation processes. Typically, a modifying agent is added at an addition point to the aqueous stream at an addition rate sufficient to change the settling or flotation properties of the solid matter in the stream. Usually, the aim is to change the settling time of said solid matter essentially to correspond to another, preferably predetermined settling time.

Industrial or municipal effluents are conventionally treated e.g. in sedimentation basins. Before feeding the effluent to a basin one or more chemicals are added to the aqueous process stream for precipitating dissolved substances and/or for gathering together small particles into larger flocs or aggregates, typically in order to improve separation efficiency by improving settling of particles in the basin. Another way is to treat the effluents in flotation units. In a flotation process, as well, the aim is to gather together small particles into larger flocs or aggregates of suitable size which are then attached to air bubbles and thereby conveyed to the surface of the flotation unit for removal.

Usually, the process stream which contains solid matter and added chemicals is continuously fed into a sedimentation basin. The process stream is held up in the sedimentation basin for a length of time which is dependent on the flow rate and the volume of the basin, the time intended to be sufficient for settling of the solid matter of the stream. Quite often, the residence time in the basin is, for example, 45 min to 20 hours or even longer. The settled process stream, i.e. the process stream from which solid matter has been removed by settling, is continuously withdrawn from the sedimentation basin as an effluent, taken from the upper part of the basin for example in the form of an overflow. The quality of the effluent is conventionally monitored by means of turbidity measurement and/or measurement of amount of suspended solids.

The quality of the effluent can be controlled by the residence time and primarily with the chemical treatment of the feed stream.

A. Mantovanelli, P. V. Ridd, Journal of Sea Research 56 (2006) 199-226, discuss a plurality of known devices for measuring settling velocities of cohesive sediment aggregates. These include hand-operated settling tubes and automated settling columns equipped with video systems, optical and laser instruments and an underwater balance. No specific teachings regarding to the installation of these devices to a water treatment process or measurement schemes are, however, given.

U.S. Pat. No. 5,431,037 and AU 2009206170 disclose examples of known methods for periodically taking and analyzing samples from a sedimentation basin for being able to control the amount of flocculant to be added to the suspension processed.

If the composition of the process stream conducted to the basin, e.g. wastewater, fluctuates greatly over time, this can cause problems because information on the efficiency of the sedimentation basin for removal of the solid matter is obtained only from the effluent. Thus, it is possible to rectify the chemical treatment, in particular the dosage and the quality of the chemical, often only with a considerable delay amounting to up to several hours. The abovementioned sampling and controlling methods suffer from this problem. In addition, their operation is sensitive to the sampling spot in the sedimentation basin.

U.S. Pat. No. 4,279,759 discloses another kind method for controlling the feed rate of water treatment chemicals to a process stream. In the method, a sample stream is obtained as a side stream of the process stream and fed with constant rate to a settling column, in which the concentration of solids is determined continuously. The method requires a continuous stream to be fed through the settling column at a suitable feed rate. Due to the continuous stream requirement, the capability of the method to determine settling properties of the sample is limited.

JP 2002253905 discloses a coagulation monitoring system where samples are taken at a plurality of stages of a coagulation treatment process. Each sample is optically measured while being in continuous movement caused by mixers. In the method, the sample is not allowed to settle in order to be able to determine the floc size at each stage.

Thus, there is a need for improved methods, in particular relating to their capability of predictive control of process streams with long processing and residence times, and their ability to determine real settling properties of the actual process stream.

In addition to treating municipal and industrial waste waters, regulation of the settling properties of the solid matter without long delays may be necessary in other industrial processes as well where the separation of solids from aqueous flows by settling is necessary. The problems related to assessing the delayed action are of particular importance when the aqueous flows are of large volumes, such as over 50 m³/h, in particular on the order of 50 to 5000 m³/h.

### SUMMARY OF THE INVENTION

It is an aim of the present invention to eliminate at least a part of the problems relating to the known art and to provide a way of treating an aqueous stream containing solid matter exhibiting first settling properties, in particular settling time, to obtain a modified aqueous stream having solid matter exhibiting second, preferably predetermined settling properties different from the first settling properties.

It is a second aim of the invention to provide a method of assessing the quality of a process flow and/or for selecting and regulating chemical addition.

The present invention is based on the idea of measuring a desired property or desired properties describing settling property of the solid matter of small samples taken from the bulk of process water after the addition of modifying agent. Based on the determined property or properties of the sample, conclusions can be drawn regarding the bulk large flow.

The method according to the invention comprises treating an aqueous stream having a first flow rate and containing solid matter exhibiting first settling properties by
adding a modifying agent, such as coagulating or flocculating agent, to the aqueous stream at an addition rate sufficient to change the settling properties of the solid matter in the aqueous stream to obtain a modified aqueous stream having solid matter exhibiting second settling properties different from the first settling properties;
conducting a sample of the modified aqueous stream to a settling vessel having a volume;
determining a settling property of the solid matter of the sample in the settling vessel; and
conducting the modified aqueous stream to a separation unit, such as a sedimentation basin or flotation unit, in which solid matter is separated from the modified aqueous stream.

In one aspect of the invention, the sample is conducted to the settling vessel batchwise and, preferably, as a sidestream of the aqueous stream.

More specifically, the method according to the present invention is characterized by what is stated in claim 1. The system is characterized by the features of claim 22.

The step of determining the settling property of the solid matter present in the settling vessel may comprise measuring content of solid matter in the sample, e.g. turbidity or solids content of the sample locally in the settling vessel after a predefined period of settling time (so called “settled turbidity” or “settled solids content”) or continuously as a function of time, including the time derivatives of these quantities, e.g. settling velocity. The settling property may also be the settling time of the measured solid matter. The modifying agent may be selected so as to change one or more of these properties.

Local measurement of turbidity or solids content of the sample is beneficial as these quantities generally obey the formula f(x,y,z,t), where x,y are horizontal and z vertical spatial coordinates within the settling vessel and t is time. “Local” in this context means that measurement data is collected only from a certain region in the settling vessel (in the vicinity of a sensor head used), the volume of the region being smaller than the volume of the settling vessel. Preferably the measurements in performed substantially in the same location in the direction of the vertical axis of the settling vessel.

According to one embodiment, the method comprises the steps of withdrawing from the aqueous stream having a first flow rate a sidestream having a second flow rate, the second flow rate being smaller that of the first flow rate. The sidestream is taken after a point where the modifying agent is added to the process stream and transferred, e.g. by conducting via a pipe to the settling vessel. Thereafter, the feed of the settling vessel is closed and, after a certain time period, the turbidity of the sample present in the settling vessel (“settled turbidity”) is determined. Preferably, said time period is at least 10 seconds, typically at least 2 minutes, in particular 5 minutes or more. In most applications, the time period is less than 1 hour. Settled turbidity can also be a turbidity value which is not changing markedly any more (i.e. less than a predefined absolute or relative amount) by increased settling time.

Optionally, depending on the determined settling property, the addition rate of the modifying agent added to the aqueous stream is then controlled. In addition to or instead of addition rate, the type of the modifying agent can be controlled.

The term “controlling the addition rate” covers controlling of volume flow per time unit and controlling of concentration of the modifying agent. “Controlling” comprises the decision and action of changing the addition rate and the decision of not changing the addition rate (=keeping the addition rate constant). Controlling can be carried out manually, semi-automatically or automatically.

According to a preferred embodiment, the conducting of the sample to the settling vessel and the measurement are carried out batchwise, sequentially in repeating cycles, in contrast to prior art methods involving both continuous feed and measurement. This means, that the settling vessel is sequentially provided with fresh feed, i.e. until its contents correspond to the main aqueous stream, the feeding is interrupted for allowing the contents of the settling vessel to settle at least partially, and the measurement of settled turbidity or other settling property is carried out during each such settling cycle at a desired location of the settling vessel. The measurement may be continuous during each settling cycle in order to obtain temporal information on settling, but he sample is not a continuous flow but a representative batch of an initial process stream. After the settling cycle, the sequence can be started over at once or after a predetermined period. The sequence may include also one or more washing steps between batches for cleaning the settling vessel, feed channel and/or measurement sensor used.

If the sample is taken as a sidestream from the main stream, the sampling process can be easily controlled by suitable valving in the sidestream channel.

Considerable advantages are obtainable by the invention. By means of the invention, the settling properties of the solid matter in the aqueous stream to be treated can be monitored online. Thus, also the control of the addition of the chemical modifying agent(s) can be made more real-time, avoiding delays of several hours caused by the residence time of the stream in the separation unit. In particular, settled turbidity is an efficient parameter for controlling feed of modification agent. In wastewater treatment, by settling a sample, sedimentation basin purification results can be predicted, and the amount of solid substance before any other treatment step can be regulated.

It is a particular advantage that potential high turbidity peaks, which are caused by abrupt variations in the content of the incoming stream, can be predicted by using the method according to the invention. By quickly regulating the addition of modifying agent(s), the adverse effect of such peaks on the purification result can be avoided or at least mitigated.

Among other treatment processes, the invention is particularly suitable for monitoring and/or controlling purification or separation processes, e.g. sedimentation or flotation.

Next the invention will be examined more closely with the aid of a detailed description and with reference to the attached drawings.

### BRIEF DESCRIPTION OF THE DRAWINGS

FIG. 1 shows a simplified scheme for a process according to an embodiment of the invention; and

FIG. 2 shows diagrammatically turbidity as a function of time in the settling vessel.

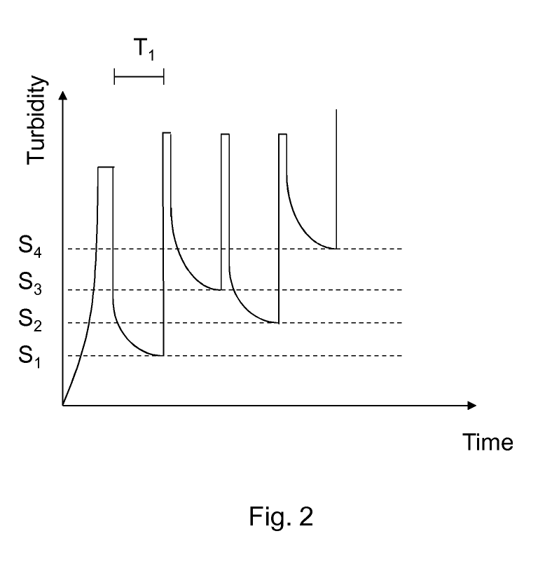

### DETAILED DESCRIPTION OF EMBODIMENTS

As was discussed above, the present invention comprises basically a method of treating an aqueous stream with a modifying agent to obtain a modified aqueous stream. The modified aqueous stream has second, preferably predetermined settling properties. In particular, settling time of the solid matter in the stream or settled turbidity of the sample may be affected.

According to a preferred embodiment, an aqueous stream is withdrawn from the side of the modified aqueous stream and based on the sidedraw, a settling property of the solid matter is determined in a settling vessel.

Instead of using a sidestream, which can be continuously drawn from the aqueous stream and fed to the settling vessel, the sampling can be carried out by a batch process of any kind.

According to a preferred embodiment, depending on the determined settling property of the solid matter in the settling vessel, the addition rate and/or type of the modifying agent is changed. It is possible to use soft sensors and models [e.g. Linguistic Equation (LE)] to assist in data interpretation and justification. As regards suitable equipment we refer to the method and apparatus for automatic dose control of chemicals, described in WO 2005/022278, the contents of which are herewith incorporated by reference.

The settled turbidity measured in the settling vessel may not directly correspond to that in the separation unit, because of different geometries of the settling vessel and separation unit, for example. However, there is proportionality between these two measurements. For example, a turbidity of x (e.g. 400 NTU, Nephelometric Turbidity Unit) in the settling vessel after a couple of minutes settling period may predict that with the present amount of modifying chemicals, the turbidity at the outlet of the separation unit after several hours will be about f×x (e.g. 40 NTU, if f=0.1), where f is a proportionality factor or function. The correlation may be found experimentally.

Thus, according to one embodiment, the method comprises
providing a proportionality factor or function relating the settled turbidity or settling time between the settling vessel and an outlet of the separation unit,
controlling, based on the determined settling property and said proportionality factor or function, the addition rate and/or type of the modifying agent so that a desired settled turbidity or settling time is achieved in the outlet of the separation unit.

The present invention also comprises a solution wherein determination of the settled turbidity is merely carried out as a monitoring step.

According to a preferred embodiment of the invention, the modifying agent and the second modifying agent, if used, are selected from coagulants and/or flocculants. The coagulant or flocculant can be selected from salts or anionic, nonionic and cationic polyelectrolytes of uni- or multivalent cations, such as sodium, calcium, magnesium, iron, aluminum, natural products such as starch, semi-synthetic polymers such as cationic starch and synthetic polymers such as acrylic polymers, polyamines, polyethylene oxides and allylic polymers, or mixtures thereof.

According to one embodiment, the aqueous stream to be treated is an industrial or municipal wastewater or effluent. In such effluents, the solid matter typically comprises organic matter, inorganic matter, biological matter and combinations thereof. The effluent is typically purified in a sedimentation tank. From this sedimentation tank an aqueous stream substantially free from solid matter is withdrawn.

In one embodiment, the modifying chemical is a coagulant, for example of the above kind, which is added in a sufficient amount to significantly reduce the settling time of the solid matter so as to obtain a second settling time which is shorter than the first settling time.

Merely adding one type of modifying agent, such as coagulant may be insufficient for achieving the desired treatment result. Therefore, a second or further modifying agent(s) can also be added to the aqueous stream. Typically, the second addition point can be placed upstream or downstream of the point at which the sidestream is taken. By the location of the sidestream, i.e sampling point, the effect of only selected modifying chemicals can be monitored or regulated. Of course, it is also possible to provide several sidestreams from different locations of the aqueous stream. For example, if two or more modifying agents are added to the stream, samples can be taken after each of respective addition points so that the effect of these modifying agents can be assessed separately.

According to one embodiment, both a coagulant and a flocculant are provided to the aqueous stream, the coagulant preferably as a first modifying agent at a first addition point and the flocculant as a second modifying agent at a second addition point downstream from the first addition point.

The aqueous stream is conducted to a separation unit comprising e.g. a sedimentation basin or a flotation unit having a volume. The ratio of the volume of the settling vessel to the volume of a separation unit is typically 1/100 to 1/10,000,000, in particular about 1/1,000 to 1/1,000,000. In other words, the settling vessel, in which the turbidity and/or any other settling property is determined in considerably much smaller in volume than the actual separation unit, whereby considerable reduction of monitoring and/or control delay is achieved.

In a preferred embodiment, the settling property determined is the turbidity of the aqueous sidestream in the settling vessel after a certain period of time, for example, 60-1200 seconds, measured from the interruption of the sidestream.

It is also possible to measure as the settling property the change of turbidity or change of amount of solid matter locally present in the sample, i.e. the settling velocity of the solid matter, over a predetermined period of time. The period can be generally about 1 to 1200 seconds long or even longer.

The measuring sequence is preferably run periodically. Typically there are 1 to 20 measuring periods/h.

Turbidity can be measured using electromagnetic radiation for example in the range of UV, visible or IR wave length. According to an exemplary embodiment, an optic absorption or scattering sensor in the wavelength range of 780 to 820 nm is used.

According to one embodiment, the sensor comprises a sensor head allowing for local measurement of turbidity or solids content of the sample. The sensor head is positioned at a distance from the bottom of the settling vessel and, optionally also at a distance from the top of the settling vessel. The sensor head can be directly in the settling vessel or behind a window provided on a wall of the settling vessel. Preferably, the sensor is arranged on or through a side wall of the settling vessel. The sensor may be arranged at an angle with respect to the side wall.

The settling vessel can be open or closed. Preferably it is of flow-through type, allowing for the settling vessel to be easily connected to a sidestream taken from the modified aqueous stream. Preferably, the sample is conducted to the settling vessel from below.

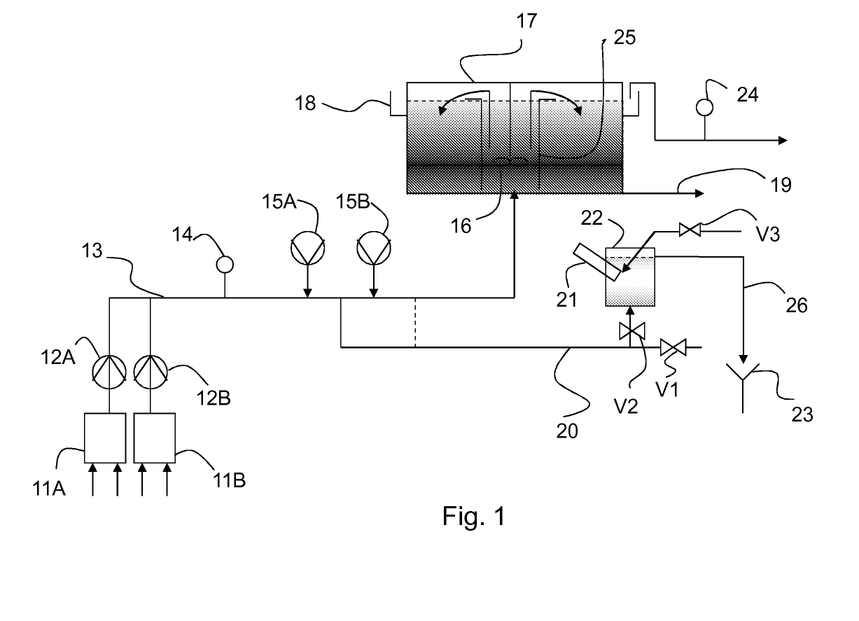

Turning now to the attached figures, it can be noted that a wastewater purification process is depicted in FIG. 1.

Reference numeral 17 designates a sedimentation basin for purification of an aqueous stream by settling. The tank is typically cylindrical. Wastewater is fed into the tank via a feed channel 13 from the bottom and allowed to flow upwards in a central tube 25. There is occasional or regular mixing of the water with an impeller 16 to prevent settling inside the central tube. The water surface is marked with dashed lines and the overflow of water from the central tube is indicated with arrows.

In the basin, the solid matter settles on the bottom and is removed through outlet pipe 19. The clarified water phase is removed as an overflow via overflow channel 18 which typically is fitted about the basin in an annular fashion. In conventional way, the turbidity of the purified water is monitored by turbidity measurement at a measurement point 24.

The wastewater can be industrial or municipal or a combination thereof. The feed to the wastewater feed channel 13 can be obtained from various sources and basins 11A, 11B and typically the pressure of the water is increased by pumps 12A, 12B. A flow meter 14 monitors the flow rate of the wastewater.

A coagulant, such as aluminium sulphate is added to the wastewater via a pump 15A. As can be seen from the drawing, there is arranged a piping at the side of the feed channel 13 at a distance (downstream) from the pump 15A and the addition point of the coagulant. The flow through the sideline 20 may be significantly smaller than in the mainline, typically less than 1/10,000 parts by volume and even in terms of flow rate. The sideline 20 is equipped with a valve V2 for regulating the flow into a small settling vessel 22. The settling vessel 22 is equipped with a sensor 21 which extends into the vessel and with an overflow pipe 26 which leads to drain 23.

Backward flow washing of the sideline 20 can be achieved by feeding water through valve V1 to the sidestream channel 20. Washing of the sensor 21 can be done by feeding water through valve V3 to the head of the sensor 21.

The operation of the settling vessel 22 is illustrated with the following example:

### EXAMPLE

### Principle of Settling

In an exemplary settling process, steps of sampling, sample line washing, settling and sensor washing are executed sequentially.

During sampling sample line controlled by valve V2 is kept open. At the beginning of sampling, sensor washing is performed for a short time period, e.g. 10 seconds, by opening valve V3. During settling (and sample line washing) valve V2 is closed. During washing of the sample line 20, valve V1 can be opened to flush the sample line 20, e.g. with raw water or other suitable water pure enough for the purpose.

A sample is taken from feed channel 13 after chemical dosage 15A. The sample flows into settling vessel 22. Flow of sample is stopped by valve V2 after a predetermined time, and then the sample taken in the settling vessel 22 is allowed to settle.

During and/or after settling, turbidity or suspended solids is measured. The sensor is washed and a new sample is taken. Once again, the turbidity value of settled sample is measured. In each sequence, turbidity or suspended solids may be measured during and/or after settling.

For control purposes, e.g. the settled turbidity value is kept constant until next value of settled turbidity is generated. Chemical additions(s) are based on e.g. the settled turbidity value.

In an exemplifying embodiment, the measuring sequence was the following:

| Sequence step | Duration |
|---|---|
| Sampling | 60 sec (1 min) |
| Sample line washing | 10 sec |
| Settling | 650 sec (10 min 50 sec) |
| Sensor washing | 10 sec |
| Total | 12 minutes 10 sec |

Settled turbidity value is generated about 5 times per hour

1. A method of treating an aqueous stream having a first flow rate and containing solid matter exhibiting first settling properties, comprising
adding modifying agent to the aqueous stream at an addition rate sufficient to change the first settling properties of the solid matter of the aqueous stream to obtain a modified aqueous stream having solid matter exhibiting second settling properties different from the first settling properties;
conducting a sample of the modified aqueous stream to a settling vessel having a volume;
determining a settling property of the solid matter of the sample in the settling vessel; and
conducting the modified aqueous stream to a separation unit in which solid matter is separated from the modified aqueous stream,
wherein
said conducting of the sample and determining of the settling property are carried out batchwise, sequentially in repeating cycles.

2. The method according to claim 1, wherein said taking the sample of the aqueous stream to the settling vessel is performed by withdrawing from the aqueous stream a sidestream having a second flow rate smaller than the first flow rate and conducting the sidestream to the settling vessel.

3. The method according to claim 2, wherein prior to said determination of the settling property of the solid matter of the sample in the settling vessel, interrupting said sidestream operating a valve in the sidestream.

4. The method according to any of the preceding claims, comprising depending on the determined settling property of the solid matter of the sample in the settling vessel, controlling the addition rate and/or type of the modifying agent.

5. The method according claim 1, comprising predicting the settling property of the modified aqueous stream from which solid matter is separated in the separation unit based on the settling property of the solid matter in the sample determined in the settling vessel.

6. The method according to claim 1, wherein the determining of the settling property of the solid matter present in the settling vessel comprises measuring locally the turbidity or solids content of the sample in the settling vessel after a predefined period of settling time.

7. The method according to claim 1, wherein the aqueous stream is selected from the group of industrial or municipal wastewaters and effluents.

8. The method according to claim 1, wherein the modifying agent is selected from coagulants and flocculants, preferably selected from water-soluble salts or anionic, nonionic and cationic polyelectrolytes of uni- or multivalent cations, such as sodium, calcium, magnesium, iron, aluminum, natural products such as starch, semi-synthetic polymers such as cationic starch and synthetic polymers such as acrylic polymers, polyamines, polyethylene oxides and allylic polymers, or a mixture thereof.

9. The method according to claim 1, wherein the modifying agent is added in a sufficient amount to significantly reduce the settling time of the solid matter so as to obtain a second settling time which is shorter than the first settling time.

10. The method according to claim 1, wherein the solid matter is selected from organic matter, inorganic matter, biological matter and combinations thereof.

11. The method according to claim 1, wherein a second modifying agent is added to the aqueous stream at a second addition point which is placed preferably downstream of the point at which said sample is taken.

12. The method according to claim 11, wherein the second modifying agent is selected from coagulants or a flocculants, preferably selected from water-soluble salts or anionic, nonionic and cationic polyelectrolytes of uni- or multivalent cations, such as sodium, calcium, magnesium, iron, aluminum, natural products such as starch, semi-synthetic polymers such as cationic starch and synthetic polymers such as acrylic polymers, polyamines, polyethylene oxides and allylic polymers or a mixture thereof.

13. The method according to any of the preceding claims claim 1, wherein the separation unit is a sedimentation basin or flotation unit having a volume.

14. The method according to claim 13, wherein the ratio of the volume of the settling vessel to the volume of the separation unit is 1/100 to 1/10,000,000, in particular about 1/1,000 to 1/1,000,000.

15. The method according to claim 1, comprising determining the settling property of the solid matter in the settling vessel sequentially by providing a fresh sample from the aqueous stream to the settling vessel between the measurements.

16. The method according to claim 15, wherein the measurement sequence is repeated 1 to 200, in particular 1 to 100, preferably 1 to 20 times/h.

17. The method according to claim 1, wherein the settling property is turbidity measured using radiation e.g. in the range of UV, visible or IR wave length.

18. The method according to claim 1, wherein the settling vessel comprises a bottom and a top and the settling property is determined using a sensor comprising a sensor head positioned at a distance from the bottom of the settling vessel and at a distance from the top of the settling vessel.

19. The method according to claim 1, wherein each sample batch is allowed to settle in the settling vessel.

20. The method according to claim 1, wherein the settled turbidity or settling time of each of the samples is determined.

21. The method according to claim 20, wherein said addition of the modifying agent is controlled in response to the settled turbidity or settling time.

22. The method according claim 1, comprising
providing a proportionality factor or function relating the settled turbidity or settling time between the settling vessel and an outlet of the separation unit,
controlling, based on the determined settling property and said proportionality factor or function, the addition rate and/or type of the modifying agent so that a desired settled turbidity or settling time is achieved in the outlet of the separation unit.

23. A water treatment system comprising
a separation unit for separating solid matter from an aqueous suspension fed to the separation unit,
a feed channel for feeding the aqueous suspension to the separation unit,
means for adding modifying agent to the aqueous stream at an addition point in the feed channel,
a settling vessel,
means arranged at said feed channel for sequentially conducting samples of the aqueous suspension batchwise to the settling vessel in repeating cycles,
means for determining at least one settling property of solid matter contained in the samples in the settling vessel, and
optionally, means for controlling addition rate and/or type of the modifying agent.

24. The water treatment system according to claim 23, wherein
the separation unit is a sedimentation basin or floatation tank,
the means for conducting a sample of the aqueous suspension to the settling vessel comprise a sidestream channel connected to the feed channel and means for sequentially taking samples batchwise from the feed channel to the settling vessel,
said means for determining at least one settling property of solid matter contained in the sample in the settling vessel are adapted to determine the turbidity or solid matter content of the sample after a predefined period of settling.

25. The water treatment system according to claim 23, being adapted to perform a method of treating an aqueous stream having a first flow rate and containing solid matter exhibiting first settling properties, comprising
adding modifying agent to the aqueous stream at an addition rate sufficient to change the first settling properties of the solid matter of the aqueous stream to obtain a modified aqueous stream having solid matter exhibiting second settling properties different from the first settling properties;
conducting a sample of the modified aqueous stream to a settling vessel having a volume;
determining a settling property of the solid matter of the sample in the settling vessel; and
conducting the modified aqueous stream to a separation unit in which solid matter is separated from the modified aqueous stream,
wherein
said conducting of the sample and determining of the settling property are carried out batchwise, sequentially in repeating cycles.
